(19) United States
(12) Patent Application Publication
(10) Pub. No.: US 2004/0073471 A1
(43) Pub. Date: Apr. 15, 2004

(54) Apparatus for and method of analysing electronic representations of business processes

(76) Inventor: Yolanta Beresnevichiene, Bristol (GB)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/611,424

(22) Filed: Jul. 2, 2003

(30) Foreign Application Priority Data
Jul. 2, 2002 (GB) 0215201.5

(51) Int. Cl. G06F 17/60

(52) U.S. Cl. 705/8

(57) ABSTRACT

An electronic representation of a business process that is analyzed with an apparatus comprises a rules database including at least one process rule for at least one process step. A process analyser determines whether a process step complies with the at least one process rule of the rules database. An indication is derived of the result based on the determination of whether the business process step complies with the at least one process rule.

### FIELD OF THE INVENTION

The present invention relates to apparatus for and methods of analysing electronic representations of business processes, and to corresponding computer apparatus operating computer programs for operating such methods.

### BACKGROUND ART

In most business processes, such as manufacturing operations, business to business transactions, quality control reviews etc the ability to hold individuals accountable for process steps or transactions is important. Hence, adequate accountability assurances must be provided in business processes, especially given the malleable nature of digital electronic records. Currently, business flow processes in electronic form are hard-coded according to specific business needs in applications such as LOTUS NOTES (trade mark). In these applications process steps are normally described in free text terms input by a system administrator, process manager or the like. The absence of a ready mechanism for tracing accountability and verifying business process history increases the legal risks facing participants of business processes. This is particularly the case for financial business transactions.

It is an aim of preferred embodiments of the present invention to obviate or overcome a disadvantage of the prior art, whether referred to herein or otherwise.

### SUMMARY OF THE INVENTION

According to a first aspect of the present invention an apparatus for analysing an electronic representation of a business process comprises a rules database including at least one process rule for at least one process step. A process analyser determines whether a process step complies with the at least one process rule of the rules database and derives a result based on the determination of whether the business process step complies with the at least one process rule.

Suitably, at least one process step is associated with at least one predetermined process rule. Suitably, the rules database comprises data of a process step that will satisfy a predetermined process rule. A given process step can satisfy a given process rule if the process step has associated with it another process step, which may be a sub-step, that satisfies the requirement of the process rule.

Suitably, the rules database comprises a plurality of process rules and the process analyser is configured to determine whether a process step complies with all applicable process rules. Not all process rules are necessarily applicable to a given process. Suitably, the rules database comprises a plurality of process rules for a plurality of process steps. The plurality of process rules need not be of the same number as the plurality of process steps.

Suitably, the apparatus further comprises a reporter for reporting the result of the process analyser. The result can be generated as a digital file and, optionally, printed.

Suitably, the apparatus further comprises a process modifier for modifying a process step of the electronic representation of the business process to comply with at least one process rule of the rules database when the process analyser determines that a rule is not being followed. Suitably, the rules database comprises a process modification database including a predetermined process modification for compliance with a given process rule. The modification can be a change, an addition, a deletion, or a combination of these.

Suitably, the rules database includes a process accountability rule. Suitably, the rules database specifies that a given process step shall include a digital signature. Suitably, the rules database specifies that a given process step shall include a time stamp. These are methods of ensuring process accountability.

Suitably, the rules database includes a process non-repudiation rule. Suitably, the rules database specifies that a given process step including a digital signature shall include a verification of the digital signature. This is one method of ensuring process non-repudiation.

Thus, there is provided apparatus for modifying an electronic representation of a business process using the apparatus referred to above.

According to a second aspect of the present invention a method of analysing an electronic representation of a business process comprises the steps of accessing a rules database including at least one process rule for at least one process step and determining whether a process step complies with at least one process rule of the rules database. A result based on the determination of whether the at least one process step complies with the at least one process rule is denied.

Suitably, at least one process step is associated with at least one predetermined process rule. Suitably, the rules database comprises data of a process step that will satisfies a predetermined process rule.

Suitably, the rules database comprises a plurality of process rules and the method comprises the step of determining whether the at least one business process step complies with all applicable process rules. A result based on the determination is denied. Suitably, the rules database comprises a plurality of process rules for a plurality of process steps.

Suitably, the method comprises the further step of reporting the result of the process analyser. The result can be generated as a digital file and, optionally, printed.

Suitably, the method further comprises the step of modifying a process step of the electronic representation of the business process to comply with the rules database. Suitably, the rules database comprises a predetermined process modification for compliance with a given rule. The modification can be a change, an addition, a deletion, or a combination of these.

Suitably, the rules database includes a process accountability rule. Suitably, the rules database specifies that a given process step shall include a digital signature. This is one method of ensuring process accountability. Another is that the rules database can specify that a given process step shall include a time stamp operation.

Suitably, the rules database includes a process non-repudiation rule. Suitably, the rules database specifies that a transaction type including a digital signature shall include a verification of the digital signature. This is one method of ensuring process non-repudiation.

According to a third aspect of the present invention a computer apparatus is arranged for carrying out the method of the second aspect of the present invention.

A fourth aspect of the invention relates to a storage device storing a program for causing a computer to perform the method of the second aspect of the present invention.

A rule in the rules database can apply to more than one business process type. A given business process type can have none, one or a plurality of rules applicable to it. Not all business process types will have applicable rules.

### BRIEF DESCRIPTION OF THE DRAWINGS

The present invention will now be described, by way of example only, with reference to the drawings that follow; in which:

FIG. 1 is a schematic illustration of a business process and an apparatus according to the present invention.

FIG. 2 is a functional flow diagram of the operation of the apparatus of an embodiment of the present invention.

FIG. 3 is a schematic illustration of the business process of FIG. 1 after modification by the present invention.

### DETAILED DESCRIPTION OF THE DRAWINGS

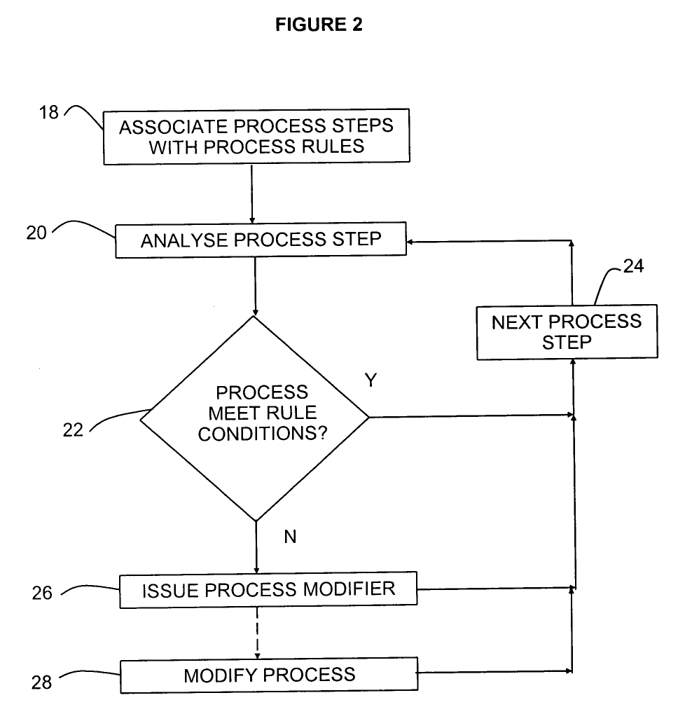

Referring to the accompanying drawings, business process apparatus 2 for analysing electronic representations of business processes comprises a business process rules database 4, business process analyser 6, a reporter 8 and a business process modifier 10. Typically the business process apparatus 2 is a digital computer (of which apparatus 2 is a schematic representation) operating under the control of a computer program as described in connection with FIG. 2.

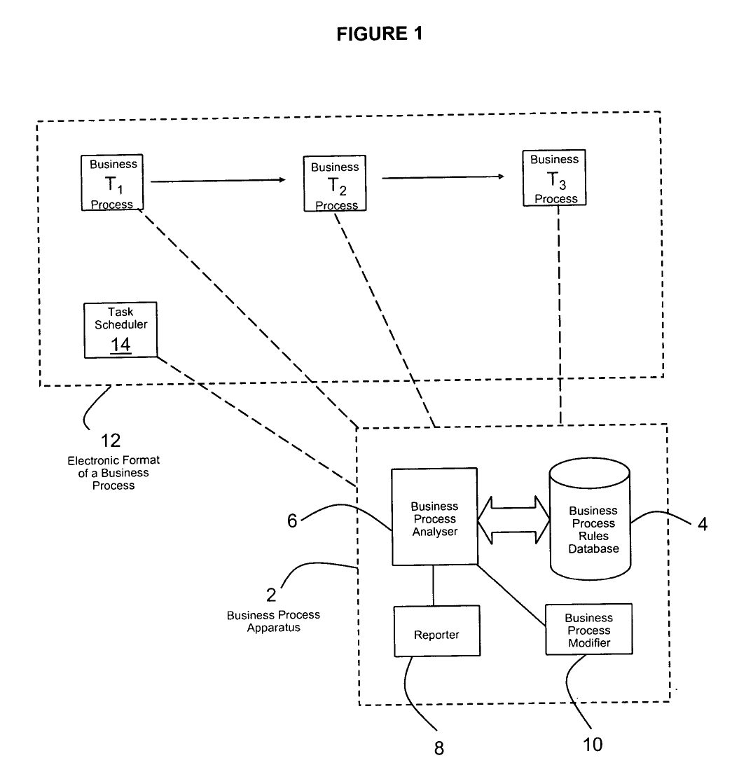

A business process can be represented in electronic format by a computer software application, such as LOTUS NOTES (trade mark) and is illustrated schematically by reference numeral 12 in FIG. 1. In the business process shown in FIG. 1, there are three process steps T₁, T₂ and T₃. As will be appreciated by those skilled in the art, most business processes involve many more steps, but FIG. 1 can be explained with reference to just a few such steps, which can form sub-steps of a larger business process. In the present example, step T₁ is a cheque being issued, typically in response to an invoice; step T₂ is a cheque being approved and step T₃ is the cheque being dispatched to the payee. Step T₃ has attached to it the requirement that the cheque approval of step T₂ must be digitally signed.

A task scheduler 14 monitors and governs the operation of the business process 12.

The rules database 4 includes rules for accountability and non-repudiation within a business process. Examples of business process rules in rules database 4 are:

Rule 1—cheque approvals must be digitally signed by the signer.

Rule 2—digital signatures must be verified by a trusted third party.

These rules relate to accountability and non-repudiation in a business process. The process of FIG. 1 is especially useful for performing rules relating to accountability and non-repudiation.

Referring to FIG. 2 of the drawings that follow, the application of the rules in rules database 4 is described using the business process 12 referred to in connection with FIG. 1.

In order for the process analyser 6 to compare the business process steps to the requirements of rules database 4, a business process needs to be set up according to certain guidelines. Normally, in the prior art, the process steps are input in free text form and therefore are unsuitable for reliable computerised analysis. Accordingly, there are provided predetermined business processes to which corresponding rules are applied. Thus, a business process application in which a business process is modelled is provided with a core set of predetermined business processes a user can select, typically via a drop down menu. The predetermined business processes available have associated with them business process rule in rules database 4. Not all business processes have corresponding process rules and some business processes are likely to have several process rules associated with them.

In an alternative mechanism, business processes are generated in a free text or other format and the user then associates either no process rule, a process rule or several process rules with the business processor. In generating a digital representation of a business process, a user is given the option for each process step of associating none, one or more business process rules with that process. If a business process is added in this way, the process also needs to be specified whether, as a process step, it satisfies the requirements of a process rule.

Thus in step 18 of FIG. 2 predetermined process rules from rules database 4 are associated with process steps of business process 12. As a minimum, one process step has one process rule associated with it, but generally many process steps in a business process have process rules applied to them.

In the present example, process T, has no process rule associated with it, business step T₂ has a requirement for a digital signature (Rule 1) as a process rule associated with it, and business step T₃ is entered by a user and a process rule requiring third party verification of a digital signature is selected (Rule 2) from rules database 4.

Also in process rules database 4 are the following business processes:

T₄—Apply digital signature

T₅—Verify digital signature with third party.

Step T4 is indicated as satisfying Rule 1 and step T5 is indicated as satisfying Rule 2. It will be appreciated that some process steps require several other process steps to be associated with them (sub-steps, in effect) to satisfy a process rule.

In step 20 the first process step T₁ of the business process 12 is analysed by process analyser 6. In step 22 process analyser 6 determines whether the process step T₁ complies with the business process rules of rules database 4. Process analyser 6 checks the business process step in the relevant process step with the rules relating to that previous step in rules database 4 to determine whether the relevant rule requirements are met. This can be a simple look-up table, a relational database etc.

In this example, the step of issuing a cheque does not have a relevant rule requirement in rules database 4 so all rule conditions are met and the process proceeds in step 24 to the next process step T₂, which is analysed in step 20. In step 22 analyser 6 determines whether process T₂ complies with the relevant rules in rules database 4.

The step of approving a cheque is a process step type to which a rule in rules database 4 applies; in this case the rule is the approval must be digitally signed. If the business process step T₂ complies with the relevant rule, the process proceeds to step 24 and moves to analyse the next process step T₃. To comply with the relevant rule, process step T₄ needs to be present in relation to process step T₃. However, in the business process 12 of FIG. 1 the step T₂ of approving a cheque does not have a requirement of applying a digital signature attached to it so the method proceeds to step 26, during which a process modifier is issued. In the case of the analysis of business process 12 reporter 8 issues the process modifier as a report or message. Alternatively or in addition the business process 12 is modified by business process modifier 10 in step 28 to insert the process step T₄ requirement that the step T₂ be digitally signed. To do this the business process analyser 2 instructs task scheduler 14 to insert in the business process 12 the new process step T₄, which is a predetermined process step to be inserted if Rule 1 above is not met. Thus there is a predetermined modification (requiring a digital signature) for compliance with a given rule (Rule 1).

In either case, the method proceeds via step 24 to the third business process step T₃ during which the cheque is sent to a payee. A prerequisite to step 13 is that a digital signature must be attached to the cheque approved from step T₂. However, if at step 22 analyzer 6 determines in relation to step T₃ that the step of checking for a digital signature does not include the process step T₅, operations proceed to step 26 during which analyzer 6 issues a process modifier. The analyzer 6 performs process modification step 28. Step T₅ involves verifying the digital signature as required by Rule 2 above. An additional step is issued as a task modifier in step 26 and optionally used to modify the business process in step 28 by the addition of step T₅ (as described above) to step T₃.

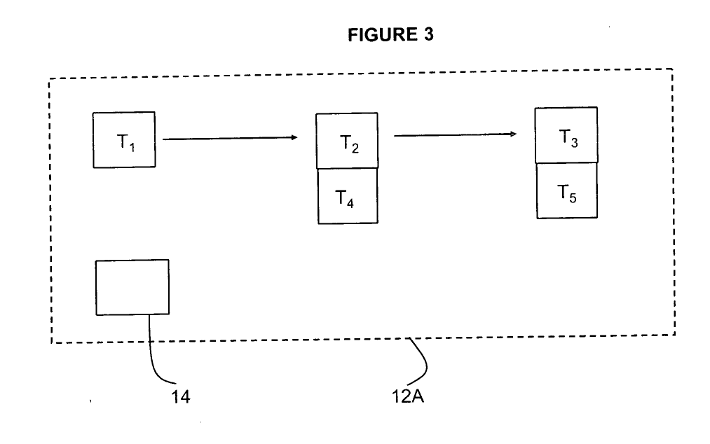

A modified business process 12A is set out in FIG. 3 of the drawings. FIG. 3 includes additional process steps T₄ and T₅.

Any process step can include sub-steps therein.

Thus, using embodiments of the present invention, electronic representations of business processes are analysed against predetermined rules. If processes to meet the rule requirements are missing, reports are generated and/or the process can be modified automatically to comply with the relevant rule or rules.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. An apparatus for analysing an electronic representation of a business process, the apparatus comprising a rules database including at least one process rule for at least one process step, and a process analyser for determining whether a process step complies with the at least one process rule of the rules database and deriving a result based on the determination of whether the business process step complies with the at least one process rule.

2. An apparatus for analysing an electronic representation of a business process according to claim 1, in which at least one process step is associated with at least one predetermined process rule.

3. An apparatus for analysing an electronic representation of a business process according to claim 2, in which the rules database comprises data of a process step that will satisfy a predetermined process rule.

4. An apparatus for analysing an electronic representation of a business process according to claim 1, in which the rules database comprises a plurality of process rules and the process analyser is configured to determine whether a process step complies with all applicable process rules.

5. An apparatus for analysing an electronic representation of a business process according to claim 4, in which the rules database comprises a plurality of process rules for a plurality of process steps.

6. An apparatus for analysing an electronic representation of a business process according to claim 1, in which the apparatus further comprises a reporter for reporting the result of the process analyser.

7. An apparatus for analysing an electronic representation of a business process according to claim 6, further including a digital file for generating the report.

8. An apparatus for analysing an electronic representation of a business process according to claim 6 further including a printer for printing.

9. An apparatus for analysing an electronic representation of a business process according to claim 1, in which the apparatus further comprises a process modifier for modifying a process step of the electronic representation of the business process to comply with at least one process rule of the rules database when it is determined by the process analyser that a rule is not complied with.

10. An apparatus for analysing an electronic representation of a business process according to claim 9, in which the rules database comprises a process modification database including a predetermined process modification for compliance with a given process rule.

11. An apparatus for analysing an electronic representation of a business process according to claim 1, in which the rules database includes a process accountability rule.

12. An apparatus for analysing an electronic representation of a business process according to claim 11, wherein the rules database is arranged to specify that a given process step shall include a digital signature.

13. An apparatus for analysing an electronic representation of a business process according to claim 11, wherein the rules database is arranged to specify that a given process step shall include a time stamp operation.

14. An apparatus for analysing an electronic representation of a business process according to claim 7 wherein the rules database includes a process non-repudiation rule.

15. An apparatus for analysing an electronic representation of a business process according to claim 14, wherein the rules database is arranged to specify that a given process step including a digital signature shall include a verification of the digital signature.

16. A method of analysing an electronic representation of a business process, the method comprising the steps of accessing a rules database including at least one process rule for at least one process step and determining whether a process step complies with at least one process rule of the rules database and deriving a result based on the determination of whether the at least one process step complies with the at least one process rule.

17. A method of analysing an electronic representation of a business process according to claim 16, in which at least one process step is associated with at least one predetermined process rule.

18. A method of analysing an electronic representation of a business process according to claim 17, in which the rules database comprises data of a process step that will satisfy a predetermined process rule.

19. A method of analysing an electronic representation of a business process according to claim 16, in which the rules database comprises a plurality of process rules and the method further comprises the step of determining whether the at least one business process step complies with all applicable process rules, and deriving a result based on said determination.

20. A method of analysing an electronic representation of a business process according to claim 19, in which the rules database comprises a plurality of process rules for a plurality of process steps.

21. A method of analysing an electronic representation of a business process according to claim 16, in which the method comprises the further step of reporting the result of the process analyser.

22. A method of analysing an electronic representation of a business process according to claim 21, in which the result is generated as a digital file.

23. A method of analysing an electronic representation of a business process according to claim 21, in which the result is printed.

24. A method of analysing an electronic representation of a business process according to claim 16, wherein the method further comprises the step of modifying a process step of the electronic representation of the business process to comply with the rules database.

25. A method of analysing an electronic representation of a business process according to claim 24, wherein the rules database comprises a predetermined process modification for compliance with a given rule.

26. A method of analysing an electronic representation of a business process according to claim 16 wherein the rules database includes a process accountability rule.

27. A method of analysing an electronic representation of a business process according to claim 26, wherein the rules database specifies that a given process step shall include a digital signature.

28. A method of analysing an electronic representation of a business process according to claim 26, wherein the rules database specifies that a given process step shall include a time stamp operation.

29. A method of analysing an electronic representation of a business process according to claim 16, wherein the rules database includes a process non-repudiation rule.

30. A method of analysing an electronic representation of a business process according to claim 29, wherein the rules database specifies that a transaction type including a digital signature shall include a verification of the digital signature.

31. A storage device storing a program for causing a computer for to carry out the method of claim 16.
